(19) United States
(12) Patent Application Publication
(10) Pub. No.: US 2023/0079658 A1
(43) Pub. Date: Mar. 16, 2023

(54) METHOD AND APPARATUS FOR MEASURING POSITION BASED ON RSSI, AND METHOD FOR SUPPORTING POSITION MEASUREMENT

(71) Applicant: ELECTRONICS AND TELECOMMUNICATIONS RESEARCH INSTITUTE, Daejeon (KR)

(72) Inventors: Mi-Ryong PARK, Daejeon (KR); Dae Ho KIM, Daejeon (KR); Jung Sik SUNG, Daejeon (KR); Seung Sik LEE, Daejeon (KR)

(21) Appl. No.: 17/690,861

(22) Filed: Mar. 9, 2022

(30) Foreign Application Priority Data
Sep. 14, 2021 (KR) 10-2021-0122280

(51) Int. Cl. G01S 5/00; G01S 5/02; H04B 17/318

(52) U.S. Cl. CPC G01S 5/0081; G01S 5/0063; G01S 5/0268; H04B 17/318

(57) ABSTRACT

An Internet of Things (IoT) device, receives, from an Access Point (AP), a beacon signal including unique identifier information of the AP, which is generated based on position coordinates of each position while at least one mobile robot equipped with the AP moves; records an RSSI value, unique identifier information of the AP, and the position coordinates from each of the received beacon signals in a reception list table; selects the best three or more RSSI values in the reception list table; calculates distances to three or more APs respectively corresponding to the three or more RSSI values by using the three or more RSSI values; and estimates the position of the IoT device by using the distances to the three or more APs.

### CROSS-REFERENCE TO RELATED APPLICATION

This application claims priority to and the benefit of Korean Patent Application No. 10-2021-0122280 filed in the Korean Intellectual Property Office on Sep. 14, 2021, the entire contents of which are incorporated herein by reference.

### BACKGROUND OF THE INVENTION

### (a) Field of the Invention

The present invention relates to a method and apparatus for measuring a position based on a Received Signal Strength Indicator (RSSI), and a method for supporting a position measurement. More particularly, the present invention relates to a method and apparatus for measuring a position based on an RSSI, and a method for supporting a position measurement that can simply measure a position based on the RSSI while minimizing an error due to radio wave interference in an embedded Internet of Things (IoT) device.

### (b) Description of the Related Art

The general Internet of Things (IoT) devices, such as lighting IoT devices installed on a ceiling or wall, create groups based on position or perform services based on position. When lighting devices are combined with the communication and become smart, communication or position-related services can be expanded.

When it is difficult to register a position every time, such as a lighting IoT device, a user mark the position where the device is installed on a drawing, collects and records position information, and registers and processes the recorded position information in a 3D/2D control system. However, due to many IoT devices, there is a difficulty in periodically checking to match the actual installation position, the collected position information, and the position information registered in the 3D/2D control system.

As a method of automatically acquiring such position information, if a wireless transmitter or Access Point (AP) is installed at a specific position and the AP corresponding to the wireless transmitter periodically transmits a beacon signal, the IoT receiving device checks a service set identifier (SSID) and a received signal strength indicator (RSSI) from received the beacon signal, calculates an approximate range based on the RSSI, and acquires an approximate position (X,Y) through approximate range-based triangulation by several RSSIs. In another method, an AP installed with a special exchange protocol and an IoT device to detect a position are used to transmit and receive signals between the IoT device and the AP, and the IoT device calculates an average delay time (Time of Arrival; ToA) between the IoT device and the AP by transmitting and receiving signals, calculates an approximate range based on the ToA, and acquires an approximate position (X,Y) by triangulation through a combination of approximate ranges with several APs. In addition, there are angle-based position measurement methods, but there are many limitations in practical use.

The position measurement method based on RSSI can be applied to various wireless communication technologies such as ultra-wideband (UWB), Wi-Fi, Zigbee, and Bluetooth, and it is convenient to simply estimate the distance. Therefore, it can be used in an embedded environment with low processing performance, but an approximation error by triangulation increases due to a decrease of signal strength by radio wave interference or a jammer, and the inaccuracy of RSSI values by reflection or interference from walls, etc. In addition, it is necessary to install several APs well, secure the position of the installed APs, accurately register the position to the APs, and record the position information in the beacon signal, and then transmit the beacon signal.

On the other hand, the ToA-based position measurement method reduces the influence of interference compared to the RSSI-based position measurement method, and thus the distance precision increases. However, it requires adding a protocol for time error calculation to the MAC layer in order to calculate the time error between the AP and the IoT device, or a precise internal timer, to accurately calculate the ToA. Therefore, it is difficult to use it in an embedded environment with low processing performance.

### SUMMARY OF THE INVENTION

The present invention has been made in an effort to provide a method and apparatus for measuring a position based on RSSIs and a method for supporting a position measurement that can simply measure a position based on RSSIs while minimizing an error due to radio wave interference in an embedded environment with low processing performance.

According to an embodiment, a method for measuring a position based on a Received Signal Strength Indicator (RSSI) in an Internet of Things (IoT) device is provided. The method for measuring a position includes: receiving, from an Access Point (AP), a beacon signal including unique identifier information of the AP, which is generated based on position coordinates of each position while at least one mobile robot equipped with the AP moves; recording an RSSI value, unique identifier information of the AP, and the position coordinates from each of the received beacon signals in a reception list table; selecting the best three or more RSSI values in the reception list table; calculating distances to three or more APs respectively corresponding to the three or more RSSI values by using the three or more RSSI values; and estimating the position of the IoT device by using the distances to the three or more APs.

The recording may include: measuring an RSSI value from the beacon signal; and recording only an RSSI values that is greater than or equal to a predetermined threshold in the reception list table.

The recording may include: measuring an RSSI value from the beacon signal; and extracting the position coordinates from the unique identifier information of the AP.

The unique identifier information of the AP may be generated by combining a predetermined Service Set Identifier (SSID) of the AP and the position coordinates.

According to another embodiment, an apparatus for measuring a position based on a Received Signal Strength Indicator (RSSI) in an Internet of Things (IoT) device is provided. The apparatus for measuring a position includes: a collector that receives, from an Access Point (AP), a beacon signal including unique identifier information of the AP, which is generated based on the position coordinates of each position while at least one mobile robot equipped with the AP moves; a signal strength measurer that measures RSSI values from the received beacon signals; a table generator that maps the unique identifier information of the AP included in each beacon signal, and the position coordinates to the RSSI value measured from the each beacon signal, and recording mapped information in a reception list table; a distance calculator that selects the best three or more RSSI values in the reception list table, and calculates a distance to a corresponding AP by using the three or more RSSI values, respectively; and a position estimator that estimates the position of the IoT device using the calculated distances.

The table generator may record only the RSSI value that is greater than or equal to a predetermined threshold in the reception list table.

The unique identifier information of the AP may be generated by combining a predetermined Service Set Identifier (SSID) of the AP and the position coordinates, and the table generator may extract the position coordinates from the unique identifier information.

According to another embodiment, a method for supporting position measurement of an Internet of Things (IoT) device in a mobile robot is provided. The method for supporting position measurement includes: calculating the current position coordinates at predetermined intervals while the mobile robot equipped with an Access Point (AP) moves; generating unique identifier information of the AP based on the calculated position coordinates; and transmitting the unique identifier information of the AP in a beacon signal at the predetermined intervals, wherein a position of the IoT device is estimated by the IoT device receiving the beacon signal using the RSSI values of the beacon signals and the position coordinates.

In the generating, the unique identifier information of the AP may be generated by combining the service set identifier (SSID) of the AP and the position coordinates.

### BRIEF DESCRIPTION OF THE DRAWINGS

FIG. 1 is a diagram for describing a method of measuring a position of a conventional RSSI-based IoT device.

FIG. 2 is a diagram illustrating a method of detecting a position of an RSSI-based IoT device according to an embodiment.

FIG. 3 is a diagram illustrating an example of a reception list table according to an embodiment.

FIG. 4 is a diagram illustrating an example of selecting an optimal RSSI value from among the RSSI values in the reception list table shown in FIG. 3.

FIG. 5 is a diagram for describing a method of estimating a position of an IoT device using a distance based on an RSSI value in the IoT device according to an embodiment.

FIG. 6 is a flowchart illustrating a method for supporting position measurement of an IoT device in a mobile robot according to an embodiment.

FIG. 7 is a flowchart illustrating a method for estimating a position in an IoT device according to an embodiment.

FIG. 8 is a diagram illustrating an apparatus for measuring a position of an IoT device according to an embodiment.

FIG. 9 is a diagram illustrating an apparatus for measuring a position of an IoT device according to another embodiment.

### DETAILED DESCRIPTION OF THE EMBODIMENTS

Hereinafter, embodiments of the present invention will be described in detail with reference to the attached drawings so that a person of ordinary skill in the art may easily implement the present invention. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, when a part is referred to “include” a certain element, it means that it may further include other elements rather than exclude other elements, unless specifically indicated otherwise.

Now, a method and apparatus for measuring a position based on RSSI, and a method for supporting a position measurement according to an embodiment, will be described in detail with reference to the drawings.

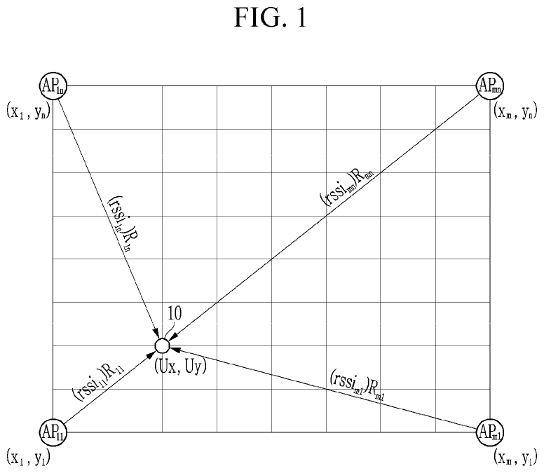

FIG. 1 is a diagram for describing a method of measuring a position of a conventional RSSI-based IoT device.

Referring to FIG. 1, when calculating the position of the IoT device 10 whose position is unknown, at least three fixed APs, for example, AP₁₁, AP₁ₙ, APₘ₁, and APₘₙ, are utilized, and distances R₁₁, R₁ₙ, Rₘ₁, and Rₘₙ between the IoT device 10 and each AP₁₁, AP₁ₙ, APₘ₁, and APₘₙ and position (Uₓ, U_{y}) of the IoT device 10 are calculated based on RSSIs of signals received from AP₁₁, AP₁ₙ, APₘ₁, and APₘ and position information (x₁, y₁), (x₁, yₙ), (xₘ, y₁), and (xₘ, yₙ) of AP₁₁, AP₁ₙ, APₘ₁, and APₘₙ.

In the distance calculation using RSSI, which is commonly used, various methods are used, such as the Friis algorithm or inversely calculating the distance through sampling according to signal transmission.

The IoT device 10 calculates the center point by trilateration or triangulation using the calculated distances R₁₁, R₁ₙ, Rₘ₁, and Rₘₙ and position information (x₁, y₁), (x₁, yₙ), (xₘ, y₁), and (xₘ, yₙ) of AP₁₁, AP₁ₙ, APₘ₁, and APₘₙ, and estimates the position (Ux, Uy) of the IoT device 10. At this time, the position information (x₁, y₁), (x₁, yₙ), (xₘ, y₁), and (xₘ, yₙ) of AP₁₁, AP₁ₙ, APₘ₁, and APₘₙ is obtained from the server where the position information of the Aps are registered, or may be obtained through a beacon signal from AP₁₁, AP₁ₙ, APₘ₁, and APₘₙ, respectively.

In the conventional RSSI-based position measurement method, if there is a wall or other devices therein, the RSSI changes, and a distance error occurs due to the changed RSSI, and thus the measurement position error of the IoT device of which the position is to be measured increases.

If the APs are densely installed and the IoT device calculates the distance based on the signal transmitted from the optimal neighboring AP, the influence of the surrounding environment can be reduced compared to the conventional RSSI-based position measurement method. However, it may be difficult to install the APs densely, and if the APs are installed densely, it may be difficult to transmit the unique position information of each AP, and even if a third channel is used, the position calculation for each AP may be complicated.

Based on these problems, by installing a wireless transmitter or AP on a single mobile robot without installing the AP densely and periodically transmitting a beacon signal according to the moving position of the mobile robot, the same effect as densely installed APs can be generated. Furthermore, by allowing the mobile robot to move while avoiding obstacles and transmit a wireless signal in the AP, it is possible to easily solve internal environmental factors such as walls and obstacles.

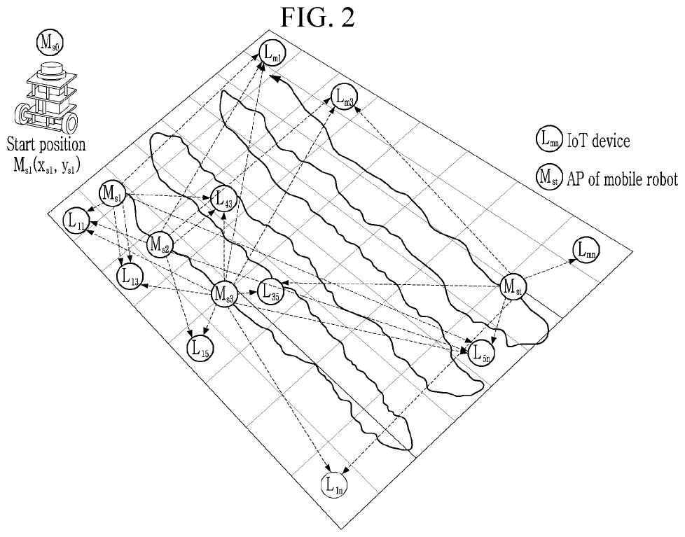

FIG. 2 is a diagram illustrating a method of detecting a position of an RSSI-based IoT device according to an embodiment.

Referring to FIG. 2, the mobile robot is a robot that can move 360 degrees on the floor. The mobile robot is equipped with Lidar to increase the accuracy of the distance to the target through light, and has the ability of continuous position calculation and map generation (SLAM: Simultaneous Localization and Mapping) through its own position calculation algorithm from the reference point. At this time, the mobile robot performs position recognition with an error of several centimeters in the map, and this error has the priori that it is significantly smaller than the existing position error of several meters by RSSI.

The mobile robot is equipped with a wireless transmitter or AP (hereinafter, referred to as “AP”), and performs position recognition with an error of several centimeters through SLAM. As the mobile robot moves, it periodically broadcasts a beacon signal including the SSID based on the current position of the AP.

An IoT device that wants to measure the position receives information including an SSID from the beacon signal. L_{xy} of FIG. 2 represents an IoT device such as a lighting device attached to the ceiling, and the three-dimensional height of the IoT device may be excluded in the embodiment.

In FIG. 2, Mₛₙ represents position coordinates generated when a mobile robot transmits a beacon signal at current position while moving after generating a map through SLAM. That is, when the mobile robot transmits a beacon signal before and moves more than a predetermined distance, the mobile robot recognizes the current position coordinates, converts the current position coordinates into the SSID of the AP, and transmits the beacon signal including the converted SSID.

The mobile robot starts from Mₛ₁ and moves on the floor, generates an SSID including the current position coordinates, and transmits a beacon signal. At this time, the mobile robot generates a new SSID by including the current position coordinates to the SSID of the AP so that the receiving IoT device can easily know the position coordinates of the AP. For example, the AP's SSID is MN and the position of a reference point determined when the mobile robot generates the initial map is set as the origin (0,0), and if the mobile robot has moved to a position 3 m from the origin (0,0) in the X-axis and 15 m from the origin (0,0) in the Y-axis, generates a new SSID of the AP called MN_X3Y15, and transmits a beacon signal including the MN_X3Y15. That is, the SSID of MN_X3Y15 indicates the point where the mobile robot moves by 3 m along the X-axis and 15 m along the Y-axis from the position of the reference point determined when the mobile robot generates the initial map.

As the mobile robot transmits a beacon signal including a new SSID while moving, the IoT device generates a reception list table based on the name of the SSID, position coordinates, and RSSI value included in each beacon signal while collecting the beacon signals.

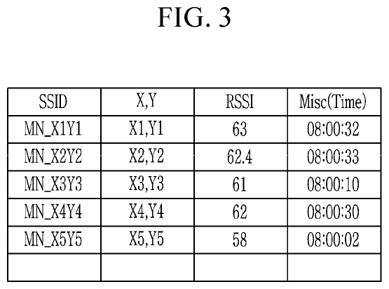

FIG. 3 is a diagram illustrating an example of a reception list table according to an embodiment.

Referring to FIG. 3, when the IoT device receives beacon signals, it records the SSID included in the received beacon signal, the position coordinates calculated through the SSID, the RSSI value, and the reception time of the received beacon signal in the reception list table.

In this case, as a method to improve distance precision, the IoT device only records RSSI values above a predefined threshold value in the reception list table in order to exclude signals transmitted from a long distance or signals attenuated by walls or surrounding obstacles. The threshold value may be set to, for example, 55, and different threshold values may be set according to the wireless method.

If a low RSSI value is used, the distance calculation error becomes large. In order to reduce the distance error, a signal with a strong RSSI value received from a short distance must be used. Accordingly, the IoT device records only the RSSI value greater than or equal to the threshold value in the reception list table.

The IoT device selects the optimum, that is, the highest predetermined number of RSSI values from among the RSSI values recorded in the reception list table, and calculates distances to the APs associated with the selected RSSI values based on the selected RSSI values. Here, the predetermined number may be set to three or more. The APs associated with the selected RSSI values indicate APs that have transmitted beacon signals corresponding to the selected RSSIs, respectively.

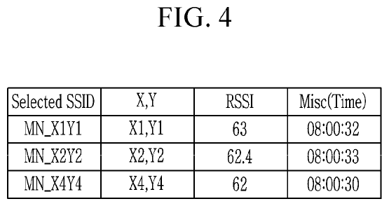

FIG. 4 is a diagram illustrating an example of selecting an optimal RSSI value from among the RSSI values in the reception list table shown in FIG. 3.

As shown in FIG. 4, the IoT device may select three RSSI values having the best RSSI values from among the RSSI values in the reception list table shown in FIG. 3.

The IoT device calculates the distances to positions of the AP associated with the RSSI values based on the selected RSSI values, and the Friis distance calculation method as in Equation 1 is most used.

$${R}_{mn} = \frac{c}{4 π f} * {10}^{\frac{rssi}{10 * N}} \qquad ( Equation 1 )$$

In Equation 1, Rₘₙ represents a distance between an IoT device and an APₙ having position coordinates of (xₘ,yₘ) in FIG. 1 as an example, and rssi is the RSSI value of a beacon signal received from the APₙ. c is the speed of light, f is the frequency, and N is a factor according to the surrounding environment of the medium, which can be calculated and applied based on measured values. For example, it may be defined and used as N=1, N=2 depending on the situation.

Using Equation 1, it is possible to simply calculate the distance R for the RSSI value. Since there are algorithms for estimating various types of distances other than the Friis distance calculation method, an effective distance calculation method may be additionally applied.

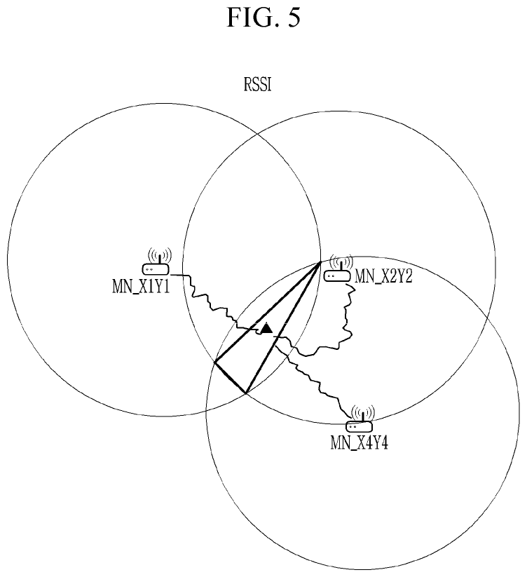

FIG. 5 is a diagram for describing a method of estimating a position of an IoT device using a distance based on an RSSI value in the IoT device according to an embodiment.

Referring to FIG. 5, the IoT device calculates distances to three APs, respectively, using the same method as in Equation 1 based on three RSSI values from three APs. At this time, as shown in FIG. 4, the position coordinates of the three APs are (X1, Y1), (X2, Y2), and (X4, Y4), respectively, and the calculated distances to the three APs are R1, R2, and R4, respectively. Then, the IoT device can estimate based on universal trilateration or triangulation to find overlapping vertices using the values of (X1,Y1)−R1, (X2,Y2)−R2, and (X4,Y4)−R4 and find the center of the vertices.

The position recognition speed of IoT device can be proportional to the moving speed of the mobile robot, so if a fast robot is used, many IoT devices can calculate position coordinates in a short time. In addition, since the 3D map precision by Lidar, a precision distance measuring device equipped on a mobile robot is within a few centimeters, it can be used in a general indoor environment with the assumption that it is considerably smaller than the distance calculation error through the strength of the wireless signal.

Since the position measurement method according to an embodiment calculates the position based on the high RSSI values using a mobile robot, compared to the conventional RSSI-based position measurement technology, it is possible to minimize the influence of interference caused by surrounding walls or objects, away from the situation in which the existing fixed AP is affected by environmental interference such as walls, steel plates, and peripheral devices depending on the position.

In addition, even in places where it is difficult to perform indoor positioning by installing wireless APs, such as basements, parking lots, and tunnels, since the mobile robot can provide wireless signals for RSSI measurement in optimal places, distance error can be reduced compared to the conventional method. In this case, a tracked robot can also be used in consideration of an uneven floor.

Meanwhile, although a single mobile robot is used in the embodiment, it may be extended to multiple mobile robots. In this case, a single result should be used for map generation and utilization.

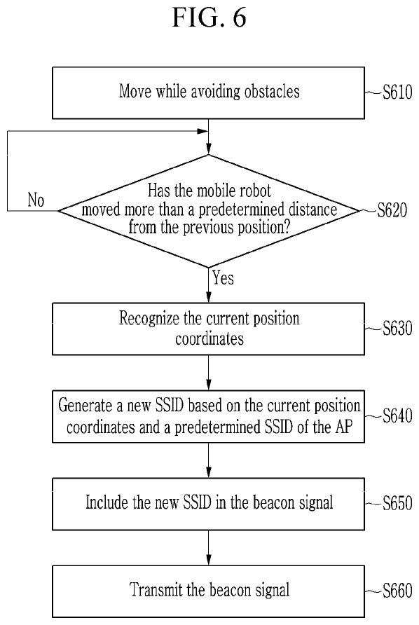

FIG. 6 is a flowchart illustrating a method for supporting position measurement of an IoT device in a mobile robot according to an embodiment.

Referring to FIG. 6, the mobile robot moves while avoiding obstacles such as walls and peripheral devices S610.

When the mobile robot moves more than a predetermined distance from the previous position while moving S620, it recognizes the current position coordinates S630. In addition, the mobile robot recognizes the current position coordinates when a predetermined period is reached while moving.

The mobile robot generates a new SSID of the AP based on the recognized current position coordinates and a predetermined SSID of the AP S640.

After the mobile robot includes the new SSID in the beacon signal S650, and transmits the beacon signal S660.

In this way, when the new SSID of the AP is generated using the current position coordinates, the IoT device can know the position coordinates of the AP from the SSID included in the beacon signal without position calculation.

In addition, the beacon signal transmission of the mobile robot can be universally used in various wireless environments regardless of wireless communication methods such as Wi-Fi, Zigbee, and Bluetooth.

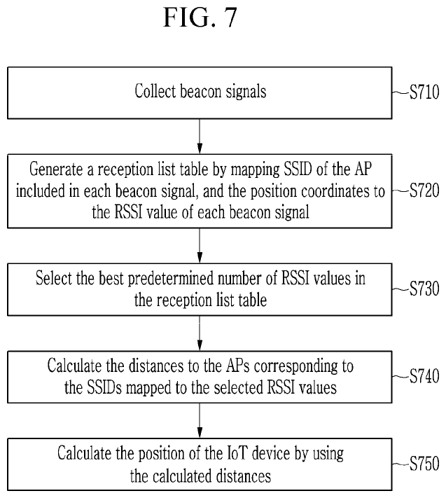

FIG. 7 is a flowchart illustrating a method for estimating a position in an IoT device according to an embodiment.

Referring to FIG. 7, the IoT device receives a beacon signal transmitted from a mobile robot.

The IoT device collects beacon signals transmitted from the mobile robot S710, and generates a reception list table by mapping the SSID of the AP included in each beacon signal, the position coordinates calculated from the SSID, etc. to the RSSI value of each beacon signal using the collected beacon signals S720. The IoT device measures the RSSI of the received beacon signal, and if the RSSI value is greater than or equal to the threshold, the IoT device can record the SSID included in the beacon signal, the position coordinates calculated from the SSID, the measured RSSI value, and the reception time of the beacon signal in the reception list table.

The IoT device selects the best predetermined number of RSSI values from among the RSSI values in the reception list table S730, and calculates the distances to the APs corresponding to the SSIDs mapped to the selected RSSI values by using the selected RSSI values S740.

The IoT device calculates the position of the IoT device by using the calculated distances S750.

In this way, the mobile robot can select the SSIDs and position coordinates of the APs in positions where the influence of the surrounding environment is minimized, and uses only good RSSI values for distance calculation, so it is possible to reduce the error of the measurement position compared to the existing RSSI-based position measurement method. In addition, position calculation is simple, so it can be utilized in IoT embedded devices with low processing performance.

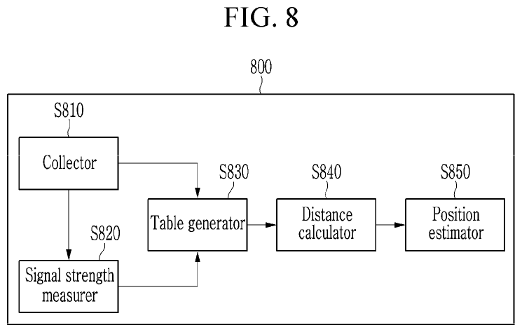

FIG. 8 is a diagram illustrating an apparatus for measuring a position of an IoT device according to an embodiment.

Referring to FIG. 8, the apparatus for measuring position 800 of the IoT device includes a collector 810, a signal strength measurer 820, a table generator 830, a distance calculator 840, and a position estimator 850.

The collector 810 collects a beacon signal including a new SSID of an AP generated based on the position coordinates of each position while the mobile robot moves.

The signal strength measurer 820 measures the RSSI values of the beacon signals collected by the collector 810.

The table generator 830 generates a reception list table by mapping the new SSID and position coordinates included in the beacon signal to the RSSI value of the corresponding beacon signal. The table generator 830 can generate the reception list table by using only RSSI values of greater than or equal to a threshold value. That is, the RSSI value of less than the threshold value is not recorded in the reception list table.

The distance calculator 840 selects the best three or more RSSI values in the reception list table, and calculates a distance from the AP of the SSID mapped to the corresponding RSSI value by using the three or more RSSI values, respectively.

The position estimator 850 estimates the position of the IoT device by using the calculated distances to three or more APs.

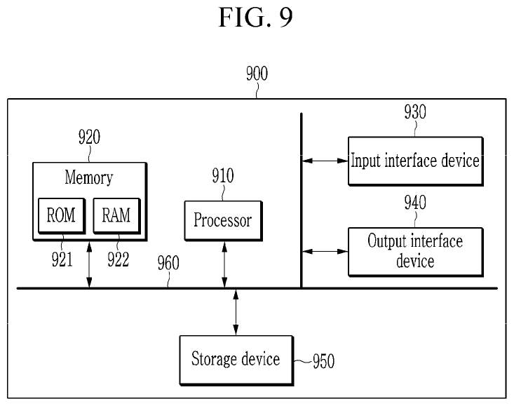

FIG. 9 is a diagram illustrating an apparatus for measuring a position of an IoT device according to another embodiment.

Referring to FIG. 9, an apparatus for measuring a position of an IoT device may represent a computing device in which the above-described method for measuring a position of the IoT device is implemented.

The apparatus for measuring a position 900 may include at least one of a processor 910, a memory 920, an input interface device 930, an output interface device 940, and a storage device 950. Each of the components may be connected by a common bus 960 to communicate with each other. In addition, each of the components may be connected through an individual interface or an individual bus centered on the processor 910 instead of the common bus 960.

The processor 910 may be implemented as various types such as an application processor (AP), a central processing unit (CPU), a graphics processing unit (GPU), etc., and may be any semiconductor device that executes a command stored in the memory 920 or the storage device 950. The processor 910 may execute a program command stored in at least one of the memory 920 and the storage device 950. The processor 910 may load program instructions for implementing at least some functions of the collector 810, the signal strength measurer 820, the table generator 830, the distance calculator 840, and the position estimator 850 described based on FIG. 8 to the memory 920, and may perform the operation described with reference to FIGS. 2 to 8.

The memory 920 and the storage device 950 may include various types of volatile or non-volatile storage media. For example, the memory 920 may include a read-only memory (ROM) 921 and a random access memory (RAM) 922. The memory 920 may be located inside or outside the processor 910, and may be connected to the processor 910 through various known means.

The input interface device 930 is configured to provide data to the processor 910. For example, the input interface device 930 may provide beacon signals input from the outside to the processor 910.

The output interface device 940 is configured to output data from the processor 910. For example, the output interface device 940 may output the position coordinates measured by the processor 910 to the outside.

The method for supporting a position measurement according to an embodiment may also be performed by at least one processor implemented in the mobile robot.

In addition, at least some of the method and apparatus for measuring a position based on an RSSI, and a method for supporting a position measurement according to an embodiment, may be implemented as a program or software executed in a computing device, and the program or software may be stored in a computer-readable medium.

In addition, at least some of the method and apparatus for measuring a position based on an RSSI, and a method for supporting a position measurement according to an embodiment, may be implemented as hardware that can be electrically connected to the computing device.

According to an embodiment, by installing an AP on a mobile robot and periodically transmitting a beacon signal according to the moving position, the same effect as densely installed APs can be generated. Furthermore, since the mobile robot moves while avoiding walls or surrounding obstacles and transmits a beacon signal, selects the best predetermined number of RSSI values, and uses the selected RSSI values for position measurement, it is possible to reduce position measurement errors caused by internal environmental factors such as radio wave interference, jammers, walls, peripheral devices, and objects.

In addition, according to an embodiment, when transmitting a beacon signal from an AP equipped on a mobile robot, compared to a method of inserting position information installed in an existing fixed AP into a beacon signal or providing position information in a detour, the position information of the AP through the SSID can be provided, the IoT device can directly calculate the position of an AP along with receiving the beacon signal and map the calculated position information with RSSI, and can be universally used in various wireless environments regardless of wireless communication method.

In addition, the method for measuring position is simple, so it can be used in embedded devices with low processing performance.

The components described in the example embodiments may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the example embodiments may be implemented by software, and the software may be recorded on a recording medium. The components, functions, and processes described in the example embodiments may be implemented by a combination of hardware and software. The method according to embodiments may be embodied as a program that is executable by a computer, and may be implemented as various recording media such as a magnetic storage medium, an optical reading medium, and a digital storage medium. Various techniques described herein may be implemented through digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing, or to control an operation of a data processing apparatus, e.g., by a programmable processor, a computer, or multiple computers. A computer program(s) may be written in any form of a programming language, including compiled or interpreted languages, and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network. Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic or magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., and magneto-optical media such as a floptical disk and a read only memory (ROM), a random access memory (RAM), a flash memory, an erasable programmable ROM (EPROM), and an electrically erasable programmable ROM (EEPROM), and any other known computer readable media. A processor and a memory may be supplemented by, or integrated into, a special purpose logic circuit. The processor may run an operating system (08) and one or more software applications that run on the OS. The processor device also may access, store, manipulate, process, and create data in response to execution of the software. For the purpose of simplicity, the description of a processor device is used as singular; however, one skilled in the art will appreciate that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media. The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination. Similarly, even though operations are described in a specific order in the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products. It should be understood that the embodiments disclosed herein are merely illustrative and are not intended to limit the scope of the invention. It will be apparent to one of ordinary skill in the art that various modifications of the embodiments may be made without departing from the spirit and scope of the claims and their equivalents.

What is claimed is:

1. A method for measuring a position based on a Received Signal Strength Indicator (RSSI) in an Internet of Things (IoT) device, the method comprising:
receiving, from an Access Point (AP), a beacon signal including unique identifier information of the AP, which is generated based on position coordinates of each position while at least one mobile robot equipped with the AP moves;
recording an RSSI value, unique identifier information of the AP, and the position coordinates from each of the received beacon signals in a reception list table;
selecting the best three or more RSSI values in the reception list table;
calculating distances to three or more APs respectively corresponding to the three or more RSSI values by using the three or more RSSI values; and
estimating the position of the IoT device by using the distances to the three or more APs.

2. The method of claim 1, wherein the recording includes:
measuring an RSSI value from the beacon signal; and
recording only an RSSI values that is greater than or equal to a predetermined threshold in the reception list table.

3. The method of claim 1, wherein the recording includes:
measuring an RSSI value from the beacon signal; and
extracting the position coordinates from the unique identifier information of the AP.

4. The method of claim 3, wherein the unique identifier information of the AP is generated by combining a predetermined Service Set Identifier (SSID) of the AP and the position coordinates.

5. An apparatus for measuring a position based on a Received Signal Strength Indicator (RSSI) in an Internet of Things (IoT) device, the apparatus comprising:
a collector that receives, from an Access Point (AP), a beacon signal including unique identifier information of the AP, which is generated based on position coordinates of each position while at least one mobile robot equipped with the AP moves;
a signal strength measurer that measures RSSI values from the received beacon signals;
a table generator that maps the unique identifier information of the AP included in each beacon signal, and the position coordinates to the RSSI value measured from the each beacon signal, and recording mapped information in a reception list table;
a distance calculator that selects the best three or more RSSI values in the reception list table, and calculates a distance to a corresponding AP by using the three or more RSSI values, respectively; and
a position estimator that estimates the position of the IoT device using the calculated distances.

6. The apparatus of claim 5, wherein the table generator records only the RSSI value that is greater than or equal to a predetermined threshold in the reception list table.

7. The apparatus of claim 5, wherein the unique identifier information of the AP is generated by combining a predetermined Service Set Identifier (SSID) of the AP and the position coordinates, and
the table generator extracts the position coordinates from the unique identifier information.

8. A method for supporting position measurement of an Internet of Things (IoT) device in a mobile robot, the method comprising:
calculating current position coordinates at predetermined intervals while the mobile robot equipped with an Access Point (AP) moves;
generating unique identifier information of the AP based on the calculated position coordinates; and
transmitting the unique identifier information of the AP in a beacon signal at the predetermined intervals,
wherein a position of the IoT device is estimated by the IoT device receiving the beacon signal using the RSSI values of the beacon signals and the position coordinates.

9. The method of claim 8, wherein in the generating, the unique identifier information of the AP is generated by combining the service set identifier (SSID) of the AP and the position coordinates.
